(19) United States
(12) Patent Application Publication
(10) Pub. No.: US 2020/0136183 A1
(43) Pub. Date: Apr. 30, 2020

(54) ELECTROLYTE AND LITHIUM ION BATTERY

(71) Applicant: Ningde Amperex Technology Limited, Ningde (CN)

(72) Inventors: Juan Ma, Ningde (CN); Wenqiang Li, Ningde (CN); Chao Tang, Ningde (CN); Shuirong Zhang, Ningde (CN)

(21) Appl. No.: 16/199,262

(22) Filed: Nov. 26, 2018

(30) Foreign Application Priority Data
Oct. 26, 2018 (CN) 201811259987.3

(51) Int. Cl. H01M 10/0567; H01M 10/0569; H01M 10/0525

(52) U.S. Cl. CPC H01M 10/0567; H01M 10/0525; H01M 10/0569

(57) ABSTRACT

The present application provides an electrolyte and a lithium ion battery. The electrolyte comprises an additive and a solvent, wherein the additive comprises a cyclic borate ester, and the solvent comprises a fluorocarbonate compound. The present application greatly improves the high temperature performance and safety performance of a lithium ion battery at a high voltage by using a cyclic borate ester as a high temperature additive and in combination with a fluorocarbonate compound.

### CROSS-REFERENCE TO RELATED APPLICATION

This application claims priority to and benefits of Chinese Patent Application Serial No. 201811259987.3, filed with the China National Intellectual Property Administration on Oct. 26, 2018, and the entire content of which is incorporated herein by reference.

### FIELD OF THE APPLICATION

Examples of the present application relates to the field of battery, in particular, to an electrolyte and a lithium ion battery.

### BACKGROUND OF THE APPLICATION

With the technological advancement and market development in the fields of smart phones, consumer drones and electric vehicles, people are increasingly demanding the performance of lithium ion batteries. Lithium-ion batteries have become the mainstream battery used in the above fields due to their high energy density, long cycle life, and no memory effect. At present, increasing energy density is one of the main research directions for improving the performance of lithium ion batteries. Increasing the operating voltage and using new high energy density materials are effective ways to increase the energy density of lithium ion batteries. Although the new lithium ion battery materials of high energy density have been widely studied, they are still in the basic research stage. At present, the mainstream lithium ion battery positive electrode material is still lithium cobaltate, lithium manganate, lithium iron phosphate, nickel cobalt manganese ternary material. Therefore, increasing the operating voltage is still an important way to increase the energy density of lithium ion batteries.

Currently, commercial lithium ion batteries operate at a voltage of 4.35V or less. If the lithium ion battery is at a high voltage of 4.35V or higher, the oxidation activity of the positive electrode material is increased and the structure is easily destroyed, and the electrolyte is also prone to decomposition under high voltage, especially under high temperature conditions, the side reaction of the electrolyte and the side reaction of the electrolyte and the interface are intensified, resulting in rapid expansion of the lithium ion battery, the safety performance of lithium ion batteries is reduced while deteriorating the performance of lithium ion battery circulation and flatulence. Therefore, researches on improving the high temperature performance and safety performance of lithium ion batteries under high voltage conditions are of great significance for the application of lithium ion batteries.

### SUMMARY OF THE APPLICATION

In order to overcome the above technical problems existing in the prior art, some examples of the present application provide an electrolyte comprising an additive and a solvent, wherein the additive comprises a cyclic borate ester, and the solvent comprises a fluorocarbonate compound.

In above electrolyte, the structural formula of the cyclic borate ester is as shown in the following formula 1:

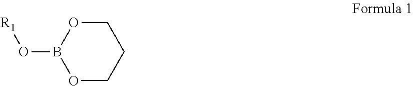

wherein R₁ is an alkyl group having 1 to 18 carbon atoms, an alkoxy group or a borate ester alkyl group having 3 to 12 carbon atoms.

In above electrolyte, the cyclic borate ester is selected from at least one of the following compounds:

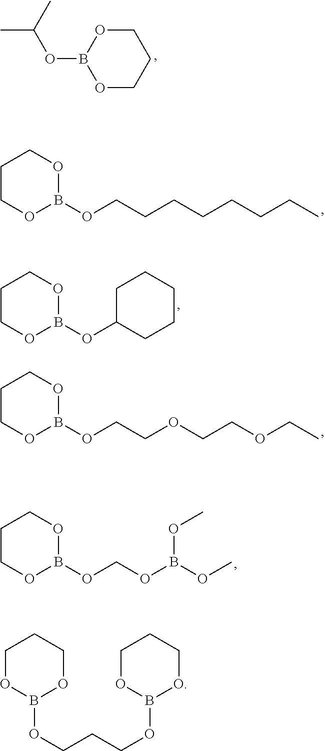

In above electrolyte, the fluorocarbonate compound is selected from at least one of the compounds represented by the following formula 2 or formula 3:

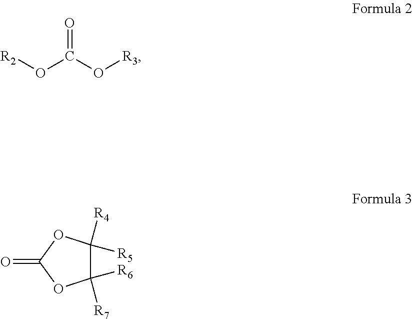

wherein R₂ and R₃ are each independently selected from an alkyl group having 1 to 6 carbon atoms or a fluoroalkyl group having 1 to 6 carbon atoms, and at least one of R₂ and R₃ contains a fluorine atom; and R₄, R₅, R₆, and R₇ are each independently selected from a hydrogen atom, a fluorine atom, an alkyl group having 1 to 6 carbon atoms, and a fluoroalkyl group having 1 to 6 carbon atoms, and at least one of R₄, R₅, R₆ and R₇ is a fluorine atom or a fluoroalkyl group having 1 to 6 carbon atoms.

In above electrolyte, the fluorocarbonate compound is selected from at least one of the following compounds:

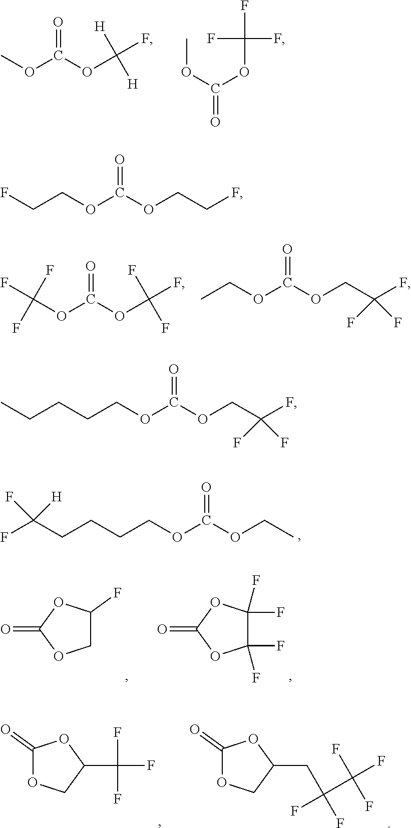

In above electrolyte, the mass percentage of the cyclic borate ester in the electrolyte is 0.01% to 2%, and the mass percentage of the fluorocarbonate compound in the electrolyte is 5% to 40%.

In above electrolyte, the additive further comprises a functional additive, and the functional additive comprises one or more of fluoroethylene carbonate, vinylene carbonate, 1,3-propane sultone, ethylene sulfate, methylene methanedisulfonate, and lithium bis(oxalate)borate.

In above electrolyte, the solvent further comprises one or more of ethylene carbonate, propylene carbonate, dimethyl carbonate, diethyl carbonate, ethyl methyl carbonate, gamma-butyrolactone, methyl propionate, ethyl propionate, n-propyl propionate, ethyl acetate, and vinyl acetate.

In above electrolyte, the electrolyte further comprises a lithium salt, and the lithium salt is selected from one or more of lithium hexafluorophosphate, lithium tetrafluoroborate, lithium hexafluoroarsenate, lithium perchlorate, lithium difluorophosphate, lithium difluorosulfonimide, and lithium bis(trifluoromethane)sulfonimide, wherein the concentration of the lithium salt is from 0.5 mol/L to 1.5 mol/L.

According to further examples of the present invention, there is also provided a lithium ion battery comprising an electrolyte, the electrolyte comprises an additive and a solvent, wherein the additive comprises a cyclic borate ester, and the solvent comprises a fluorocarbonate compound.

The present application greatly improves the high temperature performance and safety performance of a lithium ion battery at a high voltage by using a cyclic borate ester as a high temperature additive and in combination with a fluorocarbonate compound.

### DETAILED DESCRIPTION OF THE PREFERRED EXAMPLES

The technical schemes of the examples of the present application are clearly and completely described below, it is apparent that the described examples are only a part of examples of the present application, instead of all the examples. Based on the examples of the present application, all the other examples obtained by those of ordinary skill in the art are within the scope of the present application

Generally, at high voltages, the chemical stability of the electrolyte deteriorates. Especially under high temperature conditions, the thermal stability of the electrolyte is also reduced. On the one hand, due to the poor thermal stability of the lithium salt in the electrolyte, it is easy to decompose and trigger a series of side reactions. On the other hand, the carbonate system electrolyte itself is poor in oxidation resistance, and particularly in contact with the positive electrode interface, it is easy to cause side reactions at high voltage, resulting in increased impedance of the positive electrode interface and rapid consumption of electrolyte and bringing a series of safety issues while deteriorating the performance of lithium ion battery recycling, storage, etc.

The inventor of the present application found: the fluorine atom has a strong electronegativity, and the fluorine-containing fluorocarbonate compound has a high flash point and good oxidation resistance; then it is used as a solvent to replace part of the carbonate ester solvent, so that the electrolyte has high thermal stability and oxidation resistance; for the cyclic borate ester, since the outermost layer of the boron atom has only three electrons, this special electron-deficient structure makes it not only easy to interact with the anion of the lithium salt (for example, PF⁶⁻), but also reduces the thermal decomposition activity of the lithium salt, thereby inhibiting a series of side reactions caused by decomposition of the lithium salt, and improving the thermal stability of the electrolyte; at the same time, the boron atom in the cyclic borate ester may be complexed with the oxygen atom in the positive electrode material to stabilize the positive electrode interface and reduce the interfacial reaction between the positive electrode material and the electrolyte, thereby satisfying the high-temperature use requirements of lithium ion batteries at high voltages, and also improving a series of safety problems caused by side-effect gas production of lithium ion batteries.

In some examples of the present application, the cyclic boronate is used as a high temperature additive for the electrolyte in a lithium ion battery to be in combination with a fluorocarbonate compound in a solvent, so that the thermal decomposition of the lithium salt is also suppressed while increasing the oxidation resistance stability of the electrolyte itself to reduce the side reaction at the positive electrode interface at a high voltage. At the same time, membrane formation at the negative electrode of the lithium ion battery is stable, the side reaction inside the lithium ion battery is greatly reduced, and the consumption of the electrolyte is suppressed, thereby improving the thermal stability of the electrolyte at high temperatures, also improving the chemical stability of the interface between the positive electrode and the electrolyte at high voltage, and greatly improving the high temperature performance and safety performance of lithium ion batteries at high voltages.

In some examples of the present application, the structural formula of the cyclic borate ester is as shown in the following formula 1:

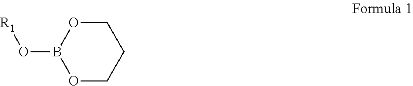

wherein R₁ is an alkyl group having 1 to 18 carbon atoms, an alkoxy group or a borate ester alkyl group having 3 to 12 carbon atoms.

In some examples of the present application, specifically, the cyclic borate ester is selected from at least one of the following compounds:

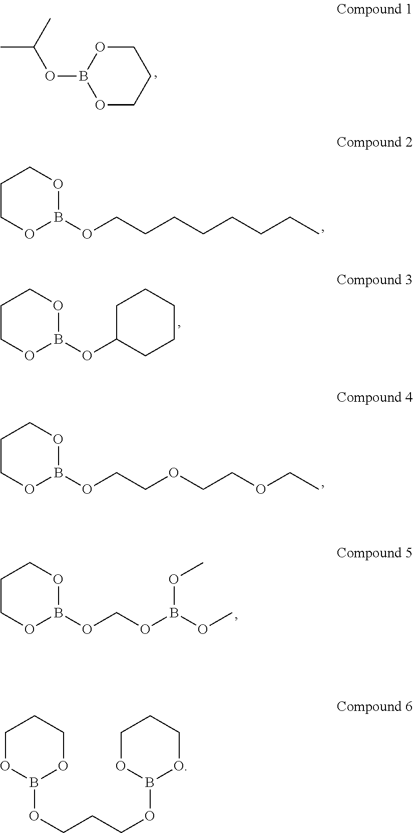

In some examples of the present application, the fluorocarbonate compound is selected from at least one of the compounds represented by the following formula 2 or formula 3:

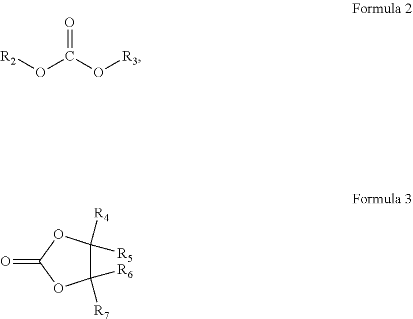

wherein R₂ and R₃ are each independently selected from an alkyl group having 1 to 6 carbon atoms or a fluoroalkyl group having 1 to 6 carbon atoms, and at least one of R₂ and R₃ contains a fluorine atom; and R₄, R₅, R₆, and R₇ are each independently selected from a hydrogen atom, a fluorine atom, an alkyl group having 1 to 6 carbon atoms, and a fluoroalkyl group having 1 to 6 carbon atoms, and at least one of R₄, R₅, R₆ and R₇ is a fluorine atom or a fluoroalkyl group having 1 to 6 carbon atoms.

In some examples of the present application, specifically, the fluorocarbonate compound is selected from at least one of the following compounds:

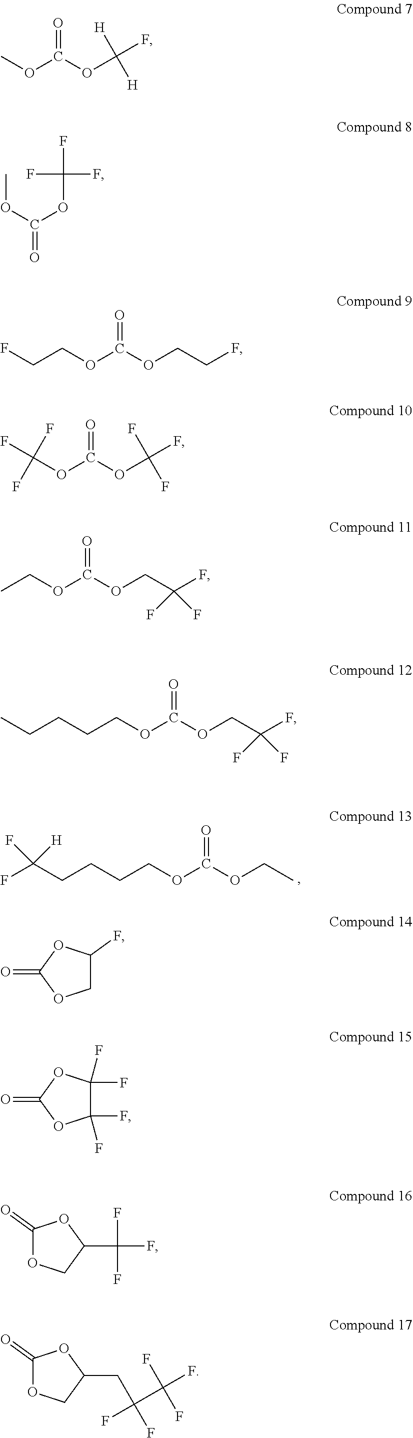

In some examples of the present application, the mass percentage of the cyclic borate ester in the electrolyte is 0.01% to 2%. When the amount of the cyclic borate ester added is low, the defect site of the positive electrode material is not effectively covered, and the free anion of the lithium salt is not sufficiently complexed, so that the side reaction of the interface and the side reaction induced by lithium salt have been subjected to a limited suppression, and the improvement effect on storage and floating charge is relatively small. And when the amount of the cyclic borate ester added is relatively high, a thick protective membrane is formed on the surface of the positive electrode material, so that the impedance on lithium ion transmission is increased, and the attenuation of cycle capacity is accelerated.

In some examples of the present application, the mass percentage of the fluorocarbonate compound in the electrolyte is 5% to 40%. When the content of the fluorinated solvent is low, the advantage of its thermal stability is not exerted. And when the content of the fluorinated solvent is high, the dissolved amount of the lithium salt is limited, and the capacity of the lithium ion battery is limited, thereby affecting the cycle performance.

In some examples of the present application, the additive further comprises a functional additive, and the functional additive may be selected from one or more of the group consisting of fluoroethylene carbonate (FEC), vinylene carbonate (VC), 1,3-propane sultone (PS), ethylene sulfate (DTD), methylene methanedisulfonate (MMDS), and lithium bis(oxalate)borate (LiBOB). Among them, FEC, VC, PS, and DTD all have excellent membrane formation properties at negative electrode. The conjugated structure of LiBOB has good thermal stability and participates in membrane formation at positive and negative electrodes, which will improve the high temperature performance of lithium ion batteries. In addition, LiBOB is fluorine-free, environmentally friendly, and the use of functional additives may improve the cycle performance of lithium ion batteries.

In some examples of the present application, the solvent further comprises one or more of ethylene carbonate (EC), propylene carbonate (PC), dimethyl carbonate (DMC), diethyl carbonate (DEC), ethyl methyl carbonate (EMC), gamma-butyrolactone (BL), methyl propionate (MP), ethyl propionate (EP), n-propyl propionate (PP), ethyl acetate (EA), and vinyl acetate (VA).

In some examples of the present application, the electrolyte further comprises a lithium salt, and the lithium salt may be selected from one or more of the group consisting of inorganic lithium salt and organic lithium salt, further, may be selected from one or more of the group consisting of lithium hexafluorophosphate (LiPF₆), lithium tetrafluoroborate (LiBF₄), lithium hexafluoroarsenate (LiAsF₆), lithium perchlorate (LiClO₄), lithium difluorophosphate (LiPO₂F₂), lithium difluorosulfonimide, and lithium bis(trifluoromethane)sulfonimide; wherein LiBF4 is non-toxic and safe; LiAsF6 has high conductivity and strong membrane formation performance at negative electrode; LiFSI has good thermal stability and high electrical conductivity. Further, the lithium salt is selected from lithium hexafluorophosphate (LiPF₆); and wherein the concentration of the lithium salt in the electrolyte is from 0.5 mol/L to 1.5 mol/L, and further, the concentration of the lithium salt in the electrolyte is from 0.8 mol/L to 1.2 mol/L.

The preparation of the lithium ion battery is described below, and the preparation method comprises: preparation of positive electrode, preparation of negative electrode, preparation of electrolyte, preparation of separator and preparation of lithium ion battery, specifically, it comprises the following steps:

Preparation of positive electrode: a positive active material such as lithium cobaltate (LiCoO₂), lithium nickel manganese cobalt ternary material, lithium iron phosphate (LiFePO₄) and lithium manganate (LiMn₂O₄), a conductive agent of SuperP, and a binder of polyvinylidene fluoride (PVDF) are mixed by weight ratio 90-98:1-2:1-3, added with N-methylpyrrolidone (NMP), stirred under the action of a vacuum mixer until the system is uniform and transparent, to obtain a positive electrode slurry, wherein the positive electrode slurry has a solid content of 70 wt % to 80 wt %; the positive electrode slurry is uniformly coated on the current collector of aluminum foil of the positive electrode; the aluminum foil is dried at 80-90° C., then cold pressed, trimmed, cut, and stripped, and then dried under vacuum at 80-90° C. for 2-6 h, to obtain a positive electrode.

Preparation of negative electrode: a negative active material such as natural graphite, artificial graphite, mesocarbon microspheres (MCMB for short), hard carbon, soft carbon, silicon, silicon-carbon composite, Li—Sn alloy, Li—Sn—O alloy, Sn, SnO, SnO₂, spinel structure of lithiated TiO₂—Li₄Ti₅O₁₂ and Li—Al alloy, a conductive agent of Super P, a thickener of sodium carboxymethyl cellulose (CMC), and a binder of styrene-butadiene rubber (SBR) are mixed by weight ratio 95-98:1-2:0.1-1:1-2, added with deionized water, and under the action of vacuum mixer, to obtain a negative electrode slurry, wherein the negative electrode slurry has a solid content of 50 wt % to 60 wt %; the negative electrode slurry is uniformly coated on the current collector of copper foil of the negative electrode; the copper foil is dried at 80-90° C., then cold pressed, trimmed, cut, and stripped, and then dried under vacuum at 110-130° C. for 10-14 h, to obtain a negative electrode.

Preparation of electrolyte: in a dry argon atmosphere glove box, ethylene carbonate (EC), ethyl methyl carbonate (EMC), and diethyl carbonate (DEC) are mixed by a mass ratio of EC:EMC:DEC=20˜40:40˜60:10˜30, added with the fluorocarbonate compound, then added with the additive, and added with the lithium salt of LiPF₆ after dissolving and uniformly dissolving, to obtain an electrolyte after uniformly mixing. Among them, the concentration of LiPF₆ is from 0.5 mol/L to 1.5 mol/L. The additive comprises the cyclic borate ester described above and optionally comprise a functional additive, wherein the functional additive comprises one or more of the group consisting of fluoroethylene carbonate (FEC), vinylene carbonate (VC), 1,3-propane sultone (PS), ethylene sulfate (DTD), methylene methanedisulfonate (MMDS), and lithium bis(oxalate)borate (LiBOB), and wherein the mass percentage of the cyclic borate ester in the electrolyte is 0.01% to 2%, the mass percentage of the fluorocarbonate compound in the electrolyte is 5% to 40%, and the mass percentage of the functional additive in the electrolyte is from 0.5% to 9%.

Preparation of separator: a 5-20 μm thick polyethylene (PE) separator is used.

Preparation of lithium ion battery: the positive electrode, the separator and the negative electrode are stacked in order, so that the separator is in a role of isolation between the positive and negative electrodes, and then wound to obtain an electrode assembly; after soldering the electrode tabs, the electrode assembly is placed in an outer foil of aluminum plastic membrane, and the prepared electrolyte is injected into the dried electrode assembly, then subjected to processes such as vacuum encapsulation, standing, chemical formation (charged to 3.3V with a constant current of 0.02 C, then charged to 3.6V with a constant current of 0.1 C), shaping, capacity testing, to obtain a soft-packed lithium ion battery.

Those skilled in the art will appreciate that the preparation method of the lithium ion battery described above are merely examples. Other materials, numerical ranges, and methods that are commonly employed in the art may be employed without departing from the disclosure.

Some specific examples and comparative examples are listed below to better illustrate the present application.

### Example 1

Preparation of positive electrode: a positive active material of lithium cobaltate (LiCoO₂), a conductive agent of Super P, and a binder of polyvinylidene fluoride are mixed by weight ratio 97.8:1:1.2, added with N-methylpyrrolidone (NMP), stirred under the action of a vacuum mixer until the system is uniform and transparent, to obtain a positive electrode slurry, wherein the positive electrode slurry has a solid content of 77 wt %; the positive electrode slurry is uniformly coated on the current collector of aluminum foil of the positive electrode; the aluminum foil is dried at 85° C., then cold pressed, trimmed, cut, and stripped, and then dried under vacuum at 85° C. for 4 h, to obtain a positive electrode.

Preparation of negative electrode: a negative active material of artificial graphite, a conductive agent of Super P, a thickener of sodium carboxymethyl cellulose (CMC), and a binder of styrene-butadiene rubber (SBR) are mixed by weight ratio 97.7:1:0.3:1, added with deionized water, and under the action of vacuum mixer, to obtain a negative electrode slurry, wherein the negative electrode slurry has a solid content of 49 wt %; the negative electrode slurry is uniformly coated on the current collector of copper foil of the negative electrode; the copper foil is dried at 85° C., then cold pressed, trimmed, cut, and stripped, and then dried under vacuum at 120° C. for 12 h, to obtain a negative electrode.

Preparation of electrolyte: in a dry argon atmosphere glove box, ethylene carbonate (EC), ethyl methyl carbonate (EMC), and diethyl carbonate (DEC) are mixed by a mass ratio of EC:EMC:DEC=30:50:20, added with the fluorocarbonate compound (Compound 8), then added with the cyclic borate ester (Compound 1), and added with the lithium salt of LiPF₆ after dissolving and uniformly dissolving, to obtain an electrolyte after uniformly mixing, wherein the concentration of LiPF₆ is 1.15 mol/L, the mass percentage of fluorocarbonate compound in the electrolyte is 20%, and the mass percentage of cyclic borate ester in the electrolyte is 0.5%.

Preparation of separator: a 6 μm thick polyethylene (PE) separator is used.

Preparation of lithium ion battery: the positive electrode, the separator and the negative electrode are stacked in order, so that the separator is in a role of isolation between the positive and negative electrodes, and then wound to obtain an electrode assembly; after soldering the electrode tabs, the electrode assembly is placed in an outer foil of aluminum plastic membrane, and the prepared electrolyte is injected into the dried electrode assembly, then subjected to processes such as vacuum encapsulation, standing, chemical formation (charged to 3.3V with a constant current of 0.02 C, then charged to 3.6V with a constant current of 0.1 C), shaping, capacity testing, to obtain a soft-packed lithium ion battery.

### Example 2

The method is identical to the preparation method of Example 1, except that the cyclic borate ester used in the electrolyte of Example 2 is Compound 2.

### Example 3

The method is identical to the preparation method of Example 1, except that the cyclic borate ester used in the electrolyte of Example 3 is Compound 3.

### Example 4

The method is identical to the preparation method of Example 1, except that the cyclic borate ester used in the electrolyte of Example 4 is Compound 4.

### Example 5

The method is identical to the preparation method of Example 1, except that the cyclic borate ester used in the electrolyte of Example 5 is a mixture of Compound 4 and Compound 5 (mass ratio is 1:1).

### Example 6

The method is identical to the preparation method of Example 1, except that the cyclic borate ester used in the electrolyte of Example 6 is Compound 6.

### Example 7

The method is identical to the preparation method of Example 1, except that the cyclic borate ester used in the electrolyte of Example 7 is Compound 6, and the fluorocarbonate compound is Compound 7.

### Example 8

The method is identical to the preparation method of Example 1, except that the cyclic borate ester used in the electrolyte of Example 8 is Compound 6, and the fluorocarbonate compound is Compound 9.

### Example 9

The method is identical to the preparation method of Example 1, except that the cyclic borate ester used in the electrolyte of Example 9 is Compound 6, and the fluorocarbonate compound is Compound 10.

### Example 10

The method is identical to the preparation method of Example 1, except that the cyclic borate ester used in the electrolyte of Example 10 is Compound 6, and the fluorocarbonate compound is Compound 11.

### Example 11

The method is identical to the preparation method of Example 1, except that the cyclic borate ester used in the electrolyte of Example 11 is Compound 6, and the fluorocarbonate compound is Compound 12.

### Example 12

The method is identical to the preparation method of Example 1, except that the cyclic borate ester used in the electrolyte of Example 12 is Compound 6, and the fluorocarbonate compound is Compound 13.

### Example 13

The method is identical to the preparation method of Example 1, except that the cyclic borate ester used in the electrolyte of Example 13 is Compound 6, and the fluorocarbonate compound is Compound 14.

### Example 14

The method is identical to the preparation method of Example 1, except that the cyclic borate ester used in the electrolyte of Example 14 is Compound 6, and the fluorocarbonate compound is a mixture of Compound 14 and Compound 15 (mass ratio is 1:1).

### Example 15

The method is identical to the preparation method of Example 1, except that the cyclic borate ester used in the electrolyte of Example 15 is Compound 6, and the fluorocarbonate compound is Compound 16.

### Example 16

The method is identical to the preparation method of Example 1, except that the cyclic borate ester used in the electrolyte of Example 16 is Compound 6, and the fluorocarbonate compound is Compound 17.

### Example 17

The method is identical to the preparation method of Example 1, except that the cyclic borate ester used in the electrolyte of Example 17 is Compound 6, and a functional additive comprising 6 wt % of fluoroethylene carbonate (FEC) based on the total mass of the electrolyte and 0.5 wt % of lithium dioxalate borate (LiBOB) based on the total mass of the electrolyte is added.

### Example 18

The method is identical to the preparation method of Example 1, except that the cyclic borate ester used in the electrolyte of Example 18 is Compound 6, and a functional additive comprising 5 wt % of fluoroethylene carbonate (FEC) based on the total mass of the electrolyte and 1.5 wt % of methylene methanedisulfonate (MMDS) based on the total mass of the electrolyte is added.

### Example 19

The method is identical to the preparation method of Example 1, except that the cyclic borate ester used in the electrolyte of Example 19 is Compound 6, and a functional additive comprising 4 wt % of fluoroethylene carbonate (FEC) based on the total mass of the electrolyte and 1.7 wt % of ethylene sulfate (DTD) based on the total mass of the electrolyte is added.

### Example 20

The method is identical to the preparation method of Example 1, except that the cyclic borate ester used in the electrolyte of Example 20 is Compound 6, and a functional additive comprising 6 wt % of fluoroethylene carbonate (FEC) based on the total mass of the electrolyte and 0.3 wt % of vinylene carbonate (VC) based on the total mass of the electrolyte is added.

### Example 21

The method is identical to the preparation method of Example 1, except that the cyclic borate ester used in the electrolyte of Example 21 is Compound 6, and a functional additive comprising 6 wt % of fluoroethylene carbonate (FEC) based on the total mass of the electrolyte and 3 wt % of 1,3-propane sultone (PS) based on the total mass of the electrolyte is added.

### Example 22

The method is identical to the preparation method of Example 1, except that the cyclic borate ester used in the electrolyte of Example 22 is Compound 6, and a functional additive comprising 0.3 wt % of vinylene carbonate (VC) based on the total mass of the electrolyte and 0.5 wt % of methylene methanedisulfonate (MMDS) based on the total mass of the electrolyte is added.

### Example 23

The method is identical to the preparation method of Example 1, except that the cyclic borate ester used in the electrolyte of Example 23 is Compound 6 accounting for 0.01 wt % of the total mass of the electrolyte; and a functional additive comprising 6 wt % of fluoroethylene carbonate (FEC) based on the total mass of the electrolyte and 0.5 wt % of lithium dioxalate borate (LiBOB) based on the total mass of the electrolyte is added in the electrolyte.

### Example 24

The method is identical to the preparation method of Example 1, except that the cyclic borate ester used in the electrolyte of Example 24 is Compound 6 accounting for 1 wt % of the total mass of the electrolyte; and a functional additive comprising 6 wt % of fluoroethylene carbonate (FEC) based on the total mass of the electrolyte and 0.5 wt % of lithium dioxalate borate (LiBOB) based on the total mass of the electrolyte is added in the electrolyte.

### Example 25

The method is identical to the preparation method of Example 1, except that the cyclic borate ester used in the electrolyte of Example 25 is Compound 6 accounting for 1.5 wt % of the total mass of the electrolyte; and a functional additive comprising 6 wt % of fluoroethylene carbonate (FEC) based on the total mass of the electrolyte and 0.5 wt % of lithium dioxalate borate (LiBOB) based on the total mass of the electrolyte is added in the electrolyte.

### Example 26

The method is identical to the preparation method of Example 1, except that the cyclic borate ester used in the electrolyte of Example 26 is Compound 6 accounting for 2 wt % of the total mass of the electrolyte; and a functional additive comprising 6 wt % of fluoroethylene carbonate (FEC) based on the total mass of the electrolyte and 0.5 wt % of lithium dioxalate borate (LiBOB) based on the total mass of the electrolyte is added in the electrolyte.

### Example 27

The method is identical to the preparation method of Example 1, except that the cyclic borate ester used in the electrolyte of Example 27 is Compound 6, the fluorocarbonate compound accounting for 5 wt % of the total mass of the electrolyte; and a functional additive comprising 6 wt % of fluoroethylene carbonate (FEC) based on the total mass of the electrolyte and 0.5 wt % of lithium dioxalate borate (LiBOB) based on the total mass of the electrolyte is added in the electrolyte.

### Example 28

The method is identical to the preparation method of Example 1, except that the cyclic borate ester used in the electrolyte of Example 28 is Compound 6, the fluorocarbonate compound accounting for 10 wt % of the total mass of the electrolyte; and a functional additive comprising 6 wt % of fluoroethylene carbonate (FEC) based on the total mass of the electrolyte and 0.5 wt % of lithium dioxalate borate (LiBOB) based on the total mass of the electrolyte is added in the electrolyte.

### Example 29

The method is identical to the preparation method of Example 1, except that the cyclic borate ester used in the electrolyte of Example 29 is Compound 6, the fluorocarbonate compound accounting for 30 wt % of the total mass of the electrolyte; and a functional additive comprising 6 wt % of fluoroethylene carbonate (FEC) based on the total mass of the electrolyte and 0.5 wt % of lithium dioxalate borate (LiBOB) based on the total mass of the electrolyte is added in the electrolyte.

### Example 30

The method is identical to the preparation method of Example 1, except that the cyclic borate ester used in the electrolyte of Example 30 is Compound 6, the fluorocarbonate compound accounting for 40 wt % of the total mass of the electrolyte; and a functional additive comprising 6 wt % of fluoroethylene carbonate (FEC) based on the total mass of the electrolyte and 0.5 wt % of lithium dioxalate borate (LiBOB) based on the total mass of the electrolyte is added in the electrolyte.

### Comparative Example 1

The method is identical to the preparation method of Example 1, except that no fluorocarbonate compound and functional additive are added to the electrolyte of Comparative Example 1.

### Comparative Example 2

The method is identical to the preparation method of Example 1, except that no additive of cyclic borate ester and functional additive are added to the electrolyte of Comparative Example 2.

### Comparative Example 3

The method is identical to the preparation method of Example 1, except that no additive of cyclic borate ester and fluorocarbonate compound are added to the electrolyte of Comparative Example 3.

The specific types and contents of the additives cyclic borate ester, fluorocarbonate compound and functional additive used in the electrolytes of respective Examples and Comparative Examples described above are shown in Table 1. In Table 1, the content of the additive cyclic borate ester, fluorocarbonate compound, and functional additive is a mass percentage calculated based on the total mass of the electrolyte.

TABLE 1

| | | | Fluorocarbonate | | Other functional | |
|---|---|---|---|---|---|---|
| | Cyclic borate ester | | compound | | additives | |
| | | Content | | Content | | Content |
| Examples | Type | (wt %) | Type | (wt %) | Type | (wt %) |
| 1 | Compound 1 | 0.5 | Compound 8 | 20 | | |
| 2 | Compound 2 | 0.5 | Compound 8 | 20 | | |
| 3 | Compound 3 | 0.5 | Compound 8 | 20 | | |
| 4 | Compound 4 | 0.5 | Compound 8 | 20 | | |
| 5 | Compound 4 + 5 | 0.5 | Compound 8 | 20 | | |
| 6 | Compound 6 | 0.5 | Compound 8 | 20 | | |
| 7 | Compound 6 | 0.5 | Compound 7 | 20 | | |
| 6 | Compound 6 | 0.5 | Compound 8 | 20 | | |
| 8 | Compound 6 | 0.5 | Compound 9 | 20 | | |
| 9 | Compound 6 | 0.5 | Compound 10 | 20 | | |
| 10 | Compound 6 | 0.5 | Compound 11 | 20 | | |
| 11 | Compound 6 | 0.5 | Compound 12 | 20 | | |
| 12 | Compound 6 | 0.5 | Compound 13 | 20 | | |
| 13 | Compound 6 | 0.5 | Compound 14 | 20 | | |
| 14 | Compound 6 | 0.5 | Compound 14 + 15 | 20 | | |
| 15 | Compound 6 | 0.5 | Compound 16 | 20 | | |
| 16 | Compound 6 | 0.5 | Compound 17 | 20 | | |
| 17 | Compound 6 | 0.5 | Compound 8 | 20 | FEC + | 6 + 0.5 |
| | | | | | LiBOB | |
| 18 | Compound 6 | 0.5 | Compound 8 | 20 | FEC + | 5 + 1.5 |
| | | | | | MMDS | |
| 19 | Compound 6 | 0.5 | Compound 8 | 20 | FEC + | 4 + 1.7 |
| | | | | | DTD | |
| 20 | Compound 6 | 0.5 | Compound 8 | 20 | FEC + | 6 + 0.3 |
| | | | | | VC | |
| 21 | Compound 6 | 0.5 | Compound 8 | 20 | FEC + | 6 + 3 |
| | | | | | PS | |
| 22 | Compound 6 | 0.5 | Compound 8 | 20 | VC + | 0.3 + 0.5 |
| | | | | | MMDS | |
| 23 | Compound 6 | 0.01 | Compound 8 | 20 | FEC + | 6 + 0.5 |
| | | | | | LiBOB | |
| 17 | Compound 6 | 0.5 | Compound 8 | 20 | FEC + | 6 + 0.5 |
| | | | | | LiBOB | |
| 24 | Compound 6 | 1 | Compound 8 | 20 | FEC + | 6 + 0.5 |
| | | | | | LiBOB | |
| 25 | Compound 6 | 1.5 | Compound 8 | 20 | FEC + | 6 + 0.5 |
| | | | | | LiBOB | |
| 26 | Compound 6 | 2 | Compound 8 | 20 | FEC + | 6 + 0.5 |
| | | | | | LiBOB | |
| 27 | Compound 6 | 0.5 | Compound 8 | 5 | FEC + | 6 + 0.5 |
| | | | | | LiBOB | |
| 28 | Compound 6 | 0.5 | Compound 8 | 10 | FEC + | 6 + 0.5 |
| | | | | | LiBOB | |
| 17 | Compound 6 | 0.5 | Compound 8 | 20 | FEC + | 6 + 0.5 |
| | | | | | LiBOB | |
| 29 | Compound 6 | 0.5 | Compound 8 | 30 | FEC + | 6 + 0.5 |
| | | | | | LiBOB | |
| 30 | Compound 6 | 0.5 | Compound 8 | 40 | FEC + | 6 + 0.5 |
| | | | | | LiBOB | |

Comparative Examples

| | | | | | | |
|---|---|---|---|---|---|---|
| 1 | Compound 6 | 0.5 | | | | |
| 2 | | | Compound 8 | 20 | | |
| 3 | | | | | FEC + | 6 + 0.5 |
| | | | | | LiBOB | |

Next, the test process of the lithium ion battery will be described. The test method is as follows:

Test for cycle performance of lithium ion battery: the lithium ion battery is placed in a 45° C. incubator and allowed to stand for 20 minutes to bring the lithium ion battery to a constant temperature. The constant temperature lithium ion battery is charged with a constant current of 0.7 C to a voltage of 4.45 V, and then charged with a constant voltage of 4.45 V until the current is 0.05 C, and then discharged with a constant current of 1 C to a voltage of 3.0 V, which is a charge and discharge cycle. The charge and discharge cycle is repeated with the capacity of the initial discharge being 100%, and the test is stopped when the discharge capacity is attenuated to 80%. And the number of cycles is recorded as an indicator for evaluating the cycle performance of a lithium ion battery.

Test for hot-box storage performance of lithium ion battery: the lithium ion battery is placed in a 45° C. hot box and allowed to stand for 20 minutes to bring the lithium ion battery to a constant temperature. The constant temperature lithium ion battery is charged with a constant current of 0.7 C to a voltage of 4.45 V, and then charged with a constant voltage of 4.45 V until the current is 0.05 C, to a fully charged state and the thickness THK0 of the lithium ion battery under full charge is tested. The lithium ion battery in the fully charged state is placed in a high-temperature furnace at 85° C. for 6 h, and the thickness THK1 of the lithium ion battery is tested, then the expansion ratio of the lithium ion battery is calculated in comparison with the initial thickness. The specific calculation is as follows:

Expansion ratio=(THK1−THK0)/THK0*100%

Test for floating charge performance of lithium ion battery: the lithium ion battery is placed in a 45° C. incubator and allowed to stand for 20 minutes to bring the lithium ion battery to a constant temperature.

The constant temperature lithium ion battery is charged with a constant current of 0.7 C to a voltage of 4.45 V, and then charged with a constant voltage of 4.45 V until the current is 0.05 C, to a fully charged state and the thickness of the lithium ion battery under full charge is tested. Then continuing to charge with a constant voltage of 4.45V, the thickness of lithium ion battery is tested every 2 days, and the expansion rate of lithium ion battery (calculation formula is the same as that for storage expansion rate) is calculated. Then the charging time at constant voltage is recorded when the expansion rate of lithium ion battery is up to 10%.

The lithium ion batteries prepared in Examples 1-30 and Comparative Examples 1-3 are subjected to performance tests according to the test methods described above. The results of the performance test are shown in Table 2 below:

TABLE 2

| | Cycle | Storage | |
|---|---|---|---|
| | performance | performance | |
| | Number of cycles | Expansion | Floating charge |
| Examples | at 45° C. | rate at 6 h | failure time/D |
| 1 | 556 | 7.42% | 30 |
| 2 | 553 | 7.51% | 31 |
| 3 | 557 | 7.39% | 30 |
| 4 | 560 | 7.89% | 32 |
| 5 | 552 | 7.67% | 33 |
| 6 | 563 | 7.02% | 36 |
| 7 | 552 | 7.90% | 34 |
| 6 | 563 | 7.02% | 36 |
| 8 | 557 | 7.85% | 35 |
| 9 | 553 | 7.90% | 36 |
| 10 | 551 | 6.87% | 33 |
| 11 | 549 | 6.92% | 32 |
| 12 | 550 | 6.81% | 34 |
| 13 | 548 | 6.93% | 35 |
| 14 | 545 | 6.91% | 33 |
| 15 | 542 | 6.90% | 36 |
| 16 | 541 | 6.92% | 35 |
| 17 | 678 | 5.53% | 44 |
| 18 | 601 | 7.21% | 38 |
| 19 | 614 | 6.42% | 40 |
| 20 | 654 | 6.47% | 42 |
| 21 | 661 | 6.23% | 42 |
| 22 | 615 | 7.36% | 40 |
| 23 | 641 | 14.43% | 24 |
| 17 | 678 | 5.53% | 44 |
| 24 | 634 | 5.31% | 46 |
| 25 | 631 | 5.17% | 47 |
| 26 | 598 | 5.02% | 48 |
| 27 | 508 | 6.87% | 36 |
| 28 | 597 | 6.27% | 38 |
| 17 | 678 | 5.53% | 44 |
| 29 | 632 | 5.22% | 46 |
| 30 | 602 | 5.20% | 46 |
| Comparative Examples | | | |
| Comparative | 456 | 8.02% | 28 |
| Example 1 | | | |
| Comparative | 537 | 18.74% | 20 |
| Example 2 | | | |
| Comparative | 453 | 19.59% | 20 |
| Example 3 | | | |

As can be seen from Examples 1 to 6 and Comparative Example 2, the addition of a cyclic borate ester significantly improves the storage expansion ratio and prolongs the floating charge time; and as can be seen from the comparison between Examples 1 and 6, the improvement of the storage expansion ratio and the floating charge time caused by the cyclic borate ester is also related to the kind of the compound; when the interface protective membrane formed by the corresponding compound is more stable at a high potential, the improvement effect is more remarkable; therefore, Compound 6 is most effective.

As can be seen from Examples 7 to 16 and Comparative Example 1, the addition of fluorocarbonate compound significantly improves cycle performance; and as can be seen from the comparison between Examples 7 and 16, the effect of fluorocarbonate compound on circulation is also related to the structure of the compound, wherein the improvement effect of linear fluorocarbonate compound is better than that of cyclic fluorocarbonate compound because the viscosity of the cyclic fluorocarbonate compound is larger than that of the chain fluorocarbonate compound, which is not conducive to the rapid transfer of lithium ions, increases the concentration polarization, and is detrimental to the performance of the cycle capacity, and because when the number of fluorine atoms is too large, the fluorine-containing by-products during the cycle are not conducive to the stability of the interface membrane, and when the alkyl chain is too long, the temporal steric is large, which is not conducive to the rapid transfer of lithium ions. From the test data, it is understood that Compound 8 is most effective in the chain fluorocarbonate compound Compounds 7 to 13.

As can be seen from the comparison among Examples 6, 17 to 22, the addition of functional additive may further improve the cycle performance; and as can be seen from Examples 17 to 22, the type of functional additive may also affect the cycle performance of lithium ion battery, wherein when FEC and LiBOB are used at the same time, the comprehensive performance of the lithium ion battery is better. This is mainly because the excellent membrane formation ability at negative electrode of the FEC is favorable for the formation and repair of the SEI membrane during the cycle, and LiBOB may also form a membrane having a stable composition on the positive and negative electrodes, respectively. Therefore, the simultaneous use of FEC and LiBOB works best.

As can be seen from the comparison among Examples 17, 23 to 26, when the cyclic borate ester is added in an amount of 0.01% to 2%, the effect of improving the cycle performance and the storage expansion ratio of the lithium ion battery is more obvious, and the effect is best when the addition amount is 0.5% to 1%. This is because when the amount of the cyclic borate ester added is low, the defect site of the positive electrode material is not effectively covered, and the free anion of the lithium salt is not sufficiently complexed, so that the side reaction of the interface and the side reaction induced by lithium salt have been subjected to a limited suppression, and the improvement effect on cycle performance and storage expansion rate is relatively small. And when the amount of the cyclic borate ester added is relatively high, a thick protective membrane is formed on the surface of the positive electrode material, so that the impedance on lithium ion transmission is increased, and the attenuation of cycle capacity is accelerated.

As can be seen from the comparison among Examples 17, 27 to 30, when the cyclic borate ester is added in an amount of 5% to 40%, the effect of improving the cycle performance and the storage expansion ratio of the lithium ion battery is more obvious, and the effect is best when the addition amount is 10% to 40%. This is because when the content of the fluorinated solvent is low, the advantage of its thermal stability is not exerted. And when the content of the fluorinated solvent is high, the dissolved amount of the lithium salt is limited, and the capacity of the lithium ion battery is limited, thereby affecting the cycle performance.

In summary, the high temperature performance and safety performance of a lithium ion battery at a high voltage may be greatly improved by using a cyclic borate ester as a high temperature additive and in combination with a fluorocarbonate compound, functional additive.

Those skilled in the art will appreciate that the above-described examples are merely exemplary examples, and various modifications, substitutions and changes may be made without departing from the spirit and scope of the present application.

What is claimed is:

1. An electrolyte, comprising an additive and a solvent,
wherein the additive comprises a cyclic borate ester, and the solvent comprises a fluorocarbonate compound.

2. The electrolyte according to claim 1, wherein the structural formula of the cyclic borate ester is as shown in the following formula 1: 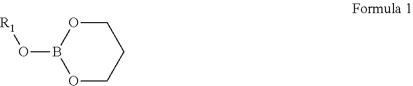
wherein R₁ is an alkyl group having 1 to 18 carbon atoms, an alkoxy group or a borate ester alkyl group having 3 to 12 carbon atoms.

3. The electrolyte according to claim 2, wherein the cyclic borate ester is selected from at least one of the following compounds:

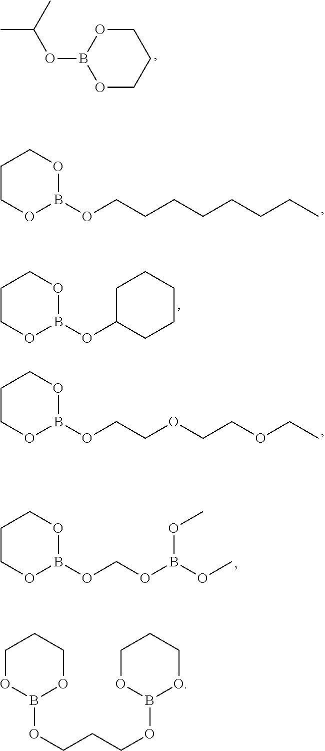

4. The electrolyte according to claim 1, wherein the fluorocarbonate compound is selected from at least one of the compounds represented by the following formula 2 or formula 3: 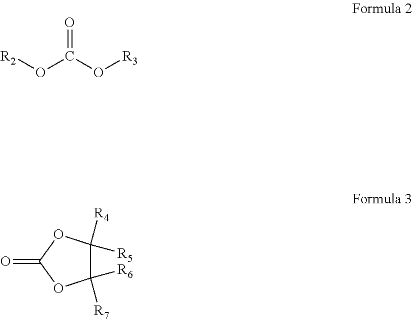
wherein R₂ and R₃ are each independently selected from an alkyl group having 1 to 6 carbon atoms or a fluoroalkyl group having 1 to 6 carbon atoms, and at least one of R₂ and R₃ contains a fluorine atom; and
R₄, R₅, R₆, and R₇ are each independently selected from a hydrogen atom, a fluorine atom, an alkyl group having 1 to 6 carbon atoms, and a fluoroalkyl group having 1 to 6 carbon atoms, and at least one of R₄, R₅, R₆ and R₇ is a fluorine atom or a fluoroalkyl group having 1 to 6 carbon atoms.

5. The electrolyte according to claim 4, wherein the fluorocarbonate compound is selected from at least one of the following compounds:

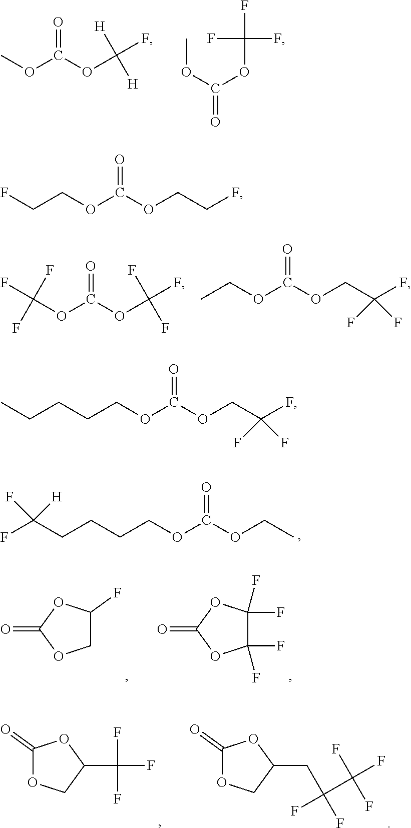

6. The electrolyte according to claim 1, wherein the mass percentage of the cyclic borate ester in the electrolyte is 0.01% to 2%, and the mass percentage of the fluorocarbonate compound in the electrolyte is 5% to 40%.

7. The electrolyte according to claim 1, wherein the additive further comprises a functional additive, and the functional additive comprises one or more of fluoroethylene carbonate, vinylene carbonate, 1,3-propane sultone, ethylene sulfate, methylene methanedisulfonate, and lithium bis(oxalate)borate.

8. The electrolyte according to claim 1, wherein the solvent further comprises one or more of ethylene carbonate, propylene carbonate, dimethyl carbonate, diethyl carbonate, ethyl methyl carbonate, gamma-butyrolactone, methyl propionate, ethyl propionate, n-propyl propionate, ethyl acetate, and vinyl acetate.

9. The electrolyte according to claim 1, wherein the electrolyte further comprises a lithium salt, and the lithium salt is selected from one or more of the group consisting of lithium hexafluorophosphate, lithium tetrafluoroborate, lithium hexafluoroarsenate, lithium perchlorate, lithium difluorophosphate, lithium difluorosulfonimide, and lithium bis(trifluoromethane)sulfonimide, wherein the concentration of the lithium salt is from 0.5 mol/L to 1.5 mol/L.

10. A lithium ion battery, comprising an electrolyte, the electrolyte comprises an additive and a solvent,
wherein the additive comprises a cyclic borate ester, and the solvent comprises a fluorocarbonate compound.

11. The lithium ion battery according to claim 10, wherein the structural formula of the cyclic borate ester is as shown in the following formula 1: 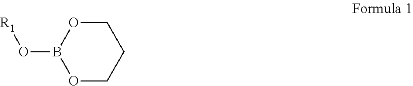
wherein R₁ is an alkyl group having 1 to 18 carbon atoms, an alkoxy group or a borate ester alkyl group having 3 to 12 carbon atoms.

12. The lithium ion battery according to claim 11, wherein the cyclic borate ester is selected from at least one of the following compounds:

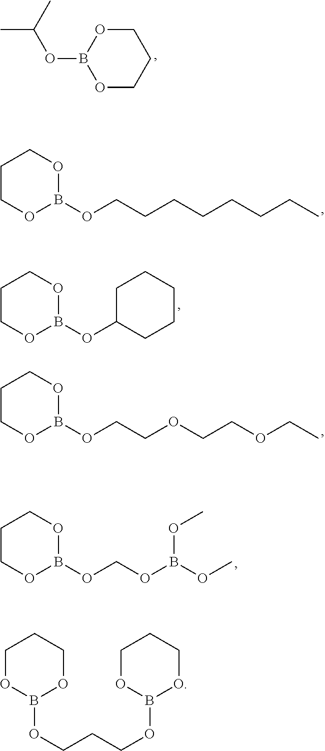

13. The lithium ion battery according to claim 10, wherein the fluorocarbonate compound is selected from at least one of the compounds represented by the following formula 2 or formula 3: 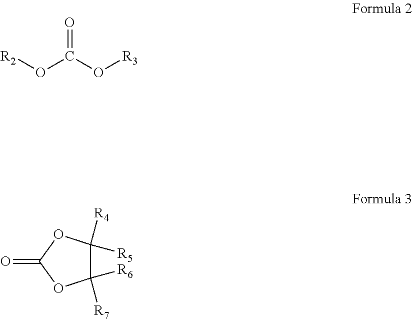
wherein R₂ and R₃ are each independently selected from an alkyl group having 1 to 6 carbon atoms or a fluoroalkyl group having 1 to 6 carbon atoms, and at least one of R₂ and R₃ contains a fluorine atom; and
R₄, R₅, R₆, and R₇ are each independently selected from a hydrogen atom, a fluorine atom, an alkyl group having 1 to 6 carbon atoms, and a fluoroalkyl group having 1 to 6 carbon atoms, and at least one of R₄, R₅, R₆ and R₇ is a fluorine atom or a fluoroalkyl group having 1 to 6 carbon atoms.

14. The lithium ion battery according to claim 13, wherein the fluorocarbonate compound is selected from at least one of the following compounds:

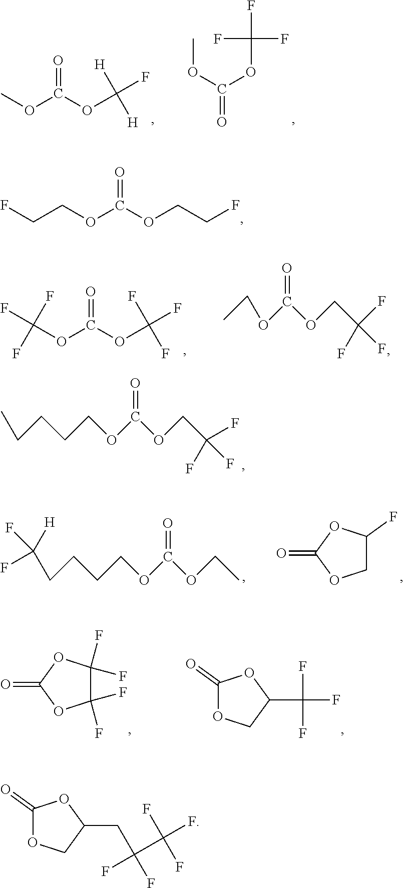

15. The lithium ion battery according to claim 10, wherein the mass percentage of the cyclic borate ester in the electrolyte is 0.01% to 2%, and the mass percentage of the fluorocarbonate compound in the electrolyte is 5% to 40%.

16. The lithium ion battery according to claim 10, wherein the additive further comprises a functional additive, and the functional additive comprises one or more of fluoroethylene carbonate, vinylene carbonate, 1,3-propane sultone, ethylene sulfate, methylene methanedisulfonate, and lithium bis(oxalate)borate.

17. The lithium ion battery according to claim 10, wherein the solvent further comprises one or more of ethylene carbonate, propylene carbonate, dimethyl carbonate, diethyl carbonate, ethyl methyl carbonate, gamma-butyrolactone, methyl propionate, ethyl propionate, n-propyl propionate, ethyl acetate, and vinyl acetate.

18. The lithium ion battery according to claim 10, wherein the electrolyte further comprises a lithium salt, and the lithium salt is selected from one or more of the group consisting of lithium hexafluorophosphate, lithium tetrafluoroborate, lithium hexafluoroarsenate, lithium perchlorate, lithium difluorophosphate, lithium difluorosulfonimide, and lithium bis(trifluoromethane)sulfonimide, wherein the concentration of the lithium salt is from 0.5 mol/L to 1.5 mol/L.
